(19) United States
(12) Patent Application Publication
(10) Pub. No.: US 2023/0390996 A1
(43) Pub. Date: Dec. 7, 2023

(54) ADDITIVE MANUFACTURING DEVICE, METHOD AND MEDICAL DEVICE THEREFOR

(71) Applicant: KUMOVIS GMBH, Munich (DE)

(72) Inventors: Stefan LEONHARDT, Munich (DE); Sebastian PAMMER, Munich (DE)

(21) Appl. No.: 18/248,679

(22) PCT Filed: Oct. 12, 2021
(86) PCT No.: PCT/EP2021/078123

§ 371 Date: Apr. 11, 2023

(30) Foreign Application Priority Data
Oct. 12, 2020 (DE) 10 2020 126 764.9

(51) Int. Cl. B29C 64/118; B29C 64/232; B29C 64/236; B29C 64/188; B29C 64/209

(52) U.S. Cl. CPC B29C 64/118; B29C 64/232; B29C 64/236; B29C 64/188; B29C 64/209; B33Y 30/00

(57) ABSTRACT

The present invention relates to an additive manufacturing device, in particular a 3D printer, for producing at least one layered component, having at least one building chamber, having at least one extrusion head which can be moved three-dimensionally within the building chamber and having a control device for control of the extrusion head in such a way that at least a first material layer of the component can be formed by the extrusion head by forming one or more infill material strands, in particular in at least one first two-dimensional plane; in that at least one second material layer of the component can be formed by the extrusion head by forming one or more infill material strands building on the first material layer, in particular in at least one second two-dimensional plane parallel to the first two-dimensional plane; and in that the extrusion head forms the first and/or the second material layer exclusively by means of the one or more infill material strands. Furthermore, the present invention relates to an additive manufacturing process, in particular a 3D printing process, for a component formed from a plurality of material layers, and to a component manufactured by the additive manufacturing process according to the invention.

The present invention relates to an additive manufacturing device, in particular a 3D printer; for producing at least one layered component with at least one construction chamber; with at least one extrusion head which can be moved three-dimensionally within the construction chamber; and with at least one control and/or regulating device for controlling and/or regulating the extrusion head.

In addition, the present invention relates to an additive manufacturing process, in particular a 3D printing process, for manufacturing a layered component.

Furthermore, the present invention relates to a medical device, in particular a medical implant, wherein the medical device is obtained by the aforementioned additive manufacturing process.

Additive or generic manufacturing processes (also called 3D printing processes) have become increasingly important due to technical progress in recent decades and will continue to do so increasingly in the future.

In connection with 3D printing of materials in general and of plastics in particular, e.g. especially for medical applications (e.g. for implants), the focus of many scientific investigations is increasingly on the component quality that can currently be achieved (warpage, tolerances, strength, toughness, etc.) as well as specific component properties (such as structural or surface properties).

The object of the present invention is a specific surface structuring of components which are produced, for example, by means of filament 3D printing (FFF—“Fused Filament Fabrication”). This structuring is particularly advantageous for medical products such as implants. This surface structuring significantly increases the surface area of the component and reduces the contact angle between the surface of the implant and a bone, for example. The surface structure of the implant thus has an osseointegrative effect, which is why it is used, for example, in bone replacement implants in orthopaedics (e.g. spinal fusion devices, CMF implants, total endoprostheses, etc.). In addition to the osseointegrative property, the surface structuring increases the primary stability of the implants (e.g. for vertebral fusion implants).

3D printing processes are already known from the prior art, also in connection with medical products, in particular implants.

For example, a 3D printing device, in particular an FFF printing device, with at least one print head unit is already known from DE 10 2015 111 504 A1, wherein the print head unit is provided in at least one operating state for melting a printing material formed at least partially by a high-performance plastic, in particular a high-performance thermoplastic.

Furthermore, EP 3 173 233 A1 discloses a three-dimensional manufacturing device comprising a processing chamber heated by a processing chamber heating unit provided therefor.

Furthermore, U.S. Pat. No. 6,722,872 B1 shows a three-dimensional modelling device intended to build three-dimensional objects within a heated construction chamber.

Furthermore, US 2015/110911 A1 shows an environment monitoring or control unit used, for example, as an interface in additive manufacturing technologies to their respective environments.

Moreover, WO 2016/063198 A1 shows a method and apparatus for manufacturing three-dimensional objects by fused deposition modelling, wherein the manufacturing apparatus comprises radiation heating elements capable of heating a surface of the object to be manufactured exposed thereto.

A method for producing a three-dimensional object with a fused deposition modelling printer can further be taken from WO 2017/108477 A1.

In the state of the art, however, the targeted surface structuring of 3D printed components has not yet been sufficiently appreciated.

It is therefore the task of the present invention to further develop an additive manufacturing device and an additive manufacturing process of the type mentioned above in an advantageous manner, in particular to the effect that medical components, in particular implants, can be manufactured with a view to an improved surface structure.

This task is solved according to the invention by an additive manufacturing device having the features of claim 1. According to this, it is provided that an additive manufacturing device, in particular a 3D printer, is provided for producing at least one component formed in layers, having at least one construction chamber, having at least one extrusion head which can be moved three-dimensionally within the construction chamber, and having at least one control and/or regulating device for controlling and/or regulating the extrusion head; and with at least one open-loop and/or closed-loop control device for open-loop and/or closed-loop control of the extrusion head, the open-loop and/or closed-loop control device being set up to open-loop and/or closed-loop control the extrusion head in such a way that at least one first material layer of the component can be formed by the extrusion head by forming one or more infill material strands, in particular in at least one first two-dimensional plane; in that at least one second material layer of the component can be formed by the extrusion head by forming one or more infill material strands building on the first material layer, in particular in at least one second two-dimensional plane parallel to the first two-dimensional plane; and in that the first and/or the second material layer can be formed by the extrusion head in each case exclusively by the one or more infill material strands.

The invention is based on the basic idea that, by controlling the extrusion head according to the invention, the additive manufacturing device is intended to produce a specific surface structure of the manufactured component so that, firstly, the surface structure is roughened and, secondly, its surface area is increased. These two properties of the manufactured component give it, among other things, so-called osseointegrative properties. In addition to the osseointegrative properties, the surface structuring also increases the primary stability of the manufactured component. Additive filament manufacturing devices are known from the prior art, which enclose a material layer with one or more so-called perimeter material strands along the outer circumferential surface after completion of the formation or application of the infill material strands on the respective outer circumferential surface. If the respective material layer has further inner circumferential surfaces, these are also enclosed with one or more perimeter material strands so that a flat or smooth surface is formed externally and internally and certain material tolerances are adhered to even more precisely. However, the present invention leads away from this approach, at least in part, as it explicitly refrains from forming or applying these perimeter material strands along the respective outer circumferential surface, at least in part or in areas. That is, the individual material layers are each formed exclusively by the one or more infill material strands. According to the invention, the manufacturing device according to claim 1 is characterised by means of at least one first and at least one second material layer. Nevertheless, it should be clarified in the context of the invention that this embodiment is not limited to a single first and a single second material layer, but that the first and the second material layer are each a plurality of first and second material layers (e.g. multiplied by a factor of 10, 100 or 1000, etc.) from which the component to be manufactured is constructed by means of the manufacturing device.

An infill material strand (also called infill web) is understood to be a material in strand form that is melted and extruded by an extrusion head (of the additive manufacturing device) in a continuous or timed manner, which is applied material layer by material layer and thus additively forms the component. An intermittently extruded infill material strand can consequently be created from an infill material strand, which is extruded along its longitudinal axis in point and/or section form and thus results in this strand (from several strands or strand sections). Within a single layer of material (e.g. within a two-dimensional plane), an infill material strand (or multiple strands) is applied according to the required geometric contour and fills this contour section by section and sequentially (hence the name “infill” material strand). The required geometric contour of a material layer is created by a corresponding infill pattern based on the one or more infill material strands. Such an infill pattern may be constructed, for example, by linear or straight sections of the infill material strand which are aligned, for example, parallel within the required geometric contour of the material layer. As soon as a contour limit is reached, a reversal point of the respective strand section is reached at the same time and a reversal movement of the extrusion head takes place, e.g. parallel in the opposite direction of the adjacent strand section until the next reversal point, etc., where this process is repeated. The reversal movement can take place under continuous extrusion or the extrusion can be stopped here briefly and only started again at the beginning of the new section. A strand section thus always extends from reversal point to reversal point within the contour limits. The required contour is thus approximated by the respective locus curves of the reversal points. Since this is an additive manufacturing process, the geometrically exact required contour of each material layer can (as the name implies) only be approximated on the basis of the locus curves of the reversal points (comparable to a numerical solution as opposed to an analytical solution of a mathematical problem). In this respect, no infill material strand completely follows the required outer and/or inner contour of the respective material layer, but this is rather to be understood as an approximation in order to fill the material layer approximately to the geometric contour. The accuracy of the approximation can be adjusted, for example, by the strand thickness, the selected strand material or the control or regulation parameters of the extrusion head. Consequently, the roughness of the resulting material layer surface can also be adjusted layer by layer and thus also globally in relation to a component surface or a component surface area. The present explanation based on linear or straight infill material strand sections is to be understood purely by way of example and serves only to provide a better illustration. The infill material strand sections can also have other shapes (e.g. curved), whereby the same applies to the infill pattern (e.g. skewed).

Furthermore, the present invention relates to an additive manufacturing process, in particular a 3D printing process, for a component formed from a plurality of material layers, comprising the following steps:
forming at least a first material layer of the component by forming one or more infill material strands, in particular within at least a first two-dimensional plane, and
forming at least a second material layer of the component by forming one or more infill material strands building on the first material layer, in particular within at least a second two-dimensional plane parallel to the first two-dimensional plane,
wherein the first and/or second material layer is or are each formed exclusively by the one or more infill material strands.

All of the structural and functional features associated with the above-described manufacturing device according to the invention and its possible embodiments can also be provided, alone or in combination, in the additive manufacturing process according to the invention and the associated embodiments, and the advantages associated therewith can be achieved.

Furthermore, it can be provided that the first material layer in the formed state has at least one first outer circumferential surface which externally delimits the first material layer, wherein at least one surface treatment is carried out at least on the first outer circumferential surface in a further step. By the surface treatment, the first outer circumferential surface can be improved with respect to its microstructure in addition to its macrostructure (essentially by dispensing with the perimeter material strands). Thus, a surface treatment can achieve a further enlargement of the first outer circumferential surface, so that the osseointegrativity can be further improved and thus even more specific properties of the medical component can be achieved and these can advantageously benefit e.g. a patient.

It is further conceivable that the second material layer in the formed state has at least one second outer circumferential surface which externally delimits the second material layer, wherein at least one surface treatment is carried out at least on the second outer circumferential surface in a further step. The advantages achieved in the context of the surface treatment of the first outer peripheral surface can also be transferred to the second outer peripheral surface.

Furthermore, it is conceivable that the surface treatment comprises at least one etching. Etching increases the surface of the first and second outer circumferential surfaces, especially on the micro level, so that the osseointegrativity of the component (especially for medical applications) is further improved.

Furthermore, it is possible that the surface treatment comprises at least coating. By means of coating, the properties of the first and second outer circumferential surfaces can be changed or improved. For example, a coating can be provided that improves the biocompatibility or the wettability of the component; after all, in many cases the first and second outer circumferential surfaces form the interface between the component and its environment (e.g. in the case of an implant, skin, organ or bone tissue). It may further be envisaged that the coating contains anti-microbial chemical compounds so that the tendency of the component to become inflamed can be reduced in the case of an implant.

In principle, it is also conceivable that the first material layer and/or the second material layer or coatings of the outer surface (or circumferential surface) each have a layer thickness in the nano range, in particular in a range up to approx. 250 nm, e.g. up to approx. 150 nm or up to approx. 100 nm.

It is also conceivable, for example, that the outer layer is biodegradable and the inner layer has a thickness in the nano range.

Furthermore, it can be provided that the first material layer and/or the second material layer each has or have a layer thickness in a range of about 0.05 mm to about 0.5 mm. This layer thickness allows a good compromise between maximising the roughness to increase the osseointegrativity of the first and second outer circumferential surfaces on the one hand, and the required tolerances of the component to be manufactured on the other hand. In addition, such layer thicknesses can be advantageously processed economically and at a reasonable speed, as material thicknesses that are too low would mean disproportionately long production times.

It is also conceivable that the one or more infill material strands of the first material layer and/or the second material layer each has or have a strand thickness in a range of about 0.1 mm to about 1 mm. This strand thickness allows a good compromise between maximising the roughness to increase the osseointegrativity of the first and second outer circumferential surfaces on the one hand, and the required tolerances of the component to be manufactured on the other hand. In addition, such strand thicknesses can be advantageously processed economically and at a reasonable speed, as strand thicknesses that are too low would mean disproportionately long production times.

Furthermore, it is conceivable that the one or more infill material strands of the first material layer and/or the second material layer is or are each straight and/or curved. In particular, straight infill material strands can be processed particularly easily and economically due to their linear or straight structure, as the control effort for the extrusion head and the resulting infill material structure can be simplified. In addition, many geometries can be approximated and formed quite accurately by linear or straight infill material strands due to the additive or layer-by-layer manufacturing process within the plane of the material layer due to the low material layer and strand thickness. However, since more complex shapes can also be found in a component, the addition of curved infill material strands to straight infill material strands is advantageous in order to accommodate these geometries as well. The respective longitudinal axes of the straight infill material strands of the first and second material layers can also be arranged at an angle to each other. Angles of 0° to 360° are conceivable, with 90° or 270° being particularly advantageous. This arrangement would then result in a rectangular or square material layer structure between the first and second material layers. Additionally or alternatively, other material layer structures such as polygonal, (e.g. honeycomb, triangular or square) concentric or circular and/or wave-shaped material layer structures are conceivable.

It is further possible that the first material layer and the second material layer each comprise at least one medically compatible plastic and/or at least one plastic that is absorbable by the human or animal body. These materials are of interest for a large number of applications for implants, so that their use in the context of the present invention is particularly advantageous. Medically compatible plastics may comprise, for example, PEEK, PEKK, PEI or PPSU, whereas plastics absorbable by the human or animal body may comprise, for example, PCL, PDO, PLLA, PDLA, PGA or PGLA. Furthermore, these plastics can be printed into material layers in such a way that cavities for fillings are created in the material views. These fillings can provide the component with complementary beneficial properties such as improved wettability, improved mechanical or chemical properties, hormone or drug delivery or further improved biocompatibility (e.g. by integrating antimicrobial fillers).

Additionally, it may be provided that the first material layer is formed solely by the one or more infill material strands and wherein the second material layer, when formed, has at least one second outer peripheral surface which externally bounds the second material layer, wherein one or more perimeter material strands are formed along the second outer peripheral surface. The advantage of these differently formed two outer peripheral surfaces (one is provided with perimeter material strands, the other is not) is that the component has surface areas (with a plurality of first and second material layers as described above) that are selectively roughened (by omitting the outer perimeter material strands), while other surface areas are selectively or not roughened and show the surface structure as already disclosed in the prior art (by applying or forming the outer perimeter material strands). For example, in the case of an implant, selective osseointegrativity can be used to selectively control bone attachment to an implant in the body already during the manufacture of the implant.

It is also conceivable that the additive manufacturing process is an FFF 3D printing process. This filament process, known in the prior art as FFF (“Fused Filament Fabrication”), is particularly advantageous for processing plastics, as it is cost-effective, economical and fast, and the challenges with regard to component accuracy are becoming increasingly manageable. The plastics are usually initially in filament form and are then fed to a print head or extrusion head of the additive manufacturing device where they are melted. This extrudes the molten plastic in strand form (in the form of the inferfill or perimeter material strand) on a plane and thus forms a material layer strand by strand according to the required geometry in order to form the component layer by layer by forming individual material layers on top of each other.

Furthermore, the present invention relates to a medical device, in particular a medical implant, wherein the medical device is obtained by the additive manufacturing process described above. manufactured by the additive manufacturing method described above and wherein the medical device comprises at least a first material layer formed by one or more infill material strands, in particular within at least a first two-dimensional plane; wherein the medical device comprises at least a second material layer formed by one or more infill material strands building on the first material layer, in particular within at least a second two-dimensional plane parallel to the first two-dimensional plane; and wherein the first and/or second material layer is or are each formed exclusively by the one or more infill material strands.

All of the structural and functional features associated with the additive manufacturing device according to the invention and with the additive manufacturing process described above, as well as their possible embodiments, can also be provided, alone or in combination, in the medical device according to the invention and the associated embodiments, and the advantages associated therewith can be achieved.

Consequently, it may be provided in this respect that the first material layer of the medical device in the formed state has at least one first outer circumferential surface which externally delimits the first material layer, wherein at least the first outer circumferential surface is surface-treated.

It is also conceivable that the second material layer in the formed state has at least one second outer circumferential surface which externally delimits the second material layer, wherein at least the second outer circumferential surface is surface-treated.

It is also conceivable that the first and/or second outer circumferential surface has an etching.

Furthermore, it is possible that the first and/or second outer circumferential surface has a coating.

In particular, it may be provided that the first material layer and the second material layer each have a layer thickness in a range from about 0.05 mm to about 0.5 mm.

Furthermore, it is conceivable that the one or more infill material strands of the first material layer and the second material layer each has or have a strand thickness in a range from about 0.1 mm to about 1 mm.

It is also possible that the one or more infill material strands of the first material layer and the second material layer are each straight and/or curved.

In addition, it is conceivable that the first material layer and the second material layer each comprise at least one medically compatible plastic and/or at least one plastic that is absorbable by the human or animal body.

Moreover, it may be provided that the first material layer is formed exclusively by the one or more infill material strands and wherein the second material layer, when formed, has at least one second outer peripheral surface which externally bounds the second material layer, wherein one or more perimeter material strands are formed along the second outer peripheral surface.

Further details and advantages of the invention will now be described in more detail with reference to the example embodiments shown in the drawings.

It shows:

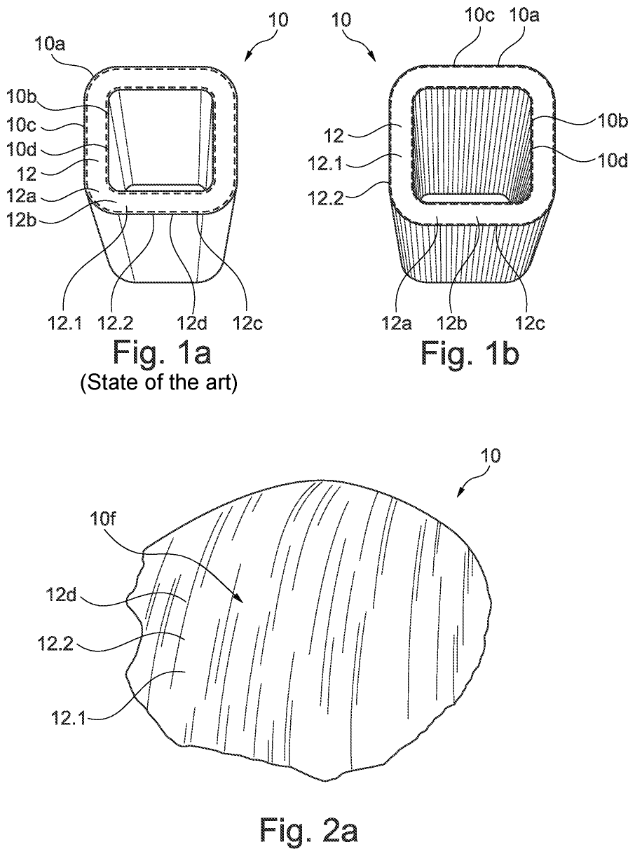

FIG. 1a is a schematic perspective view of an example embodiment of a prior art additively manufactured component;

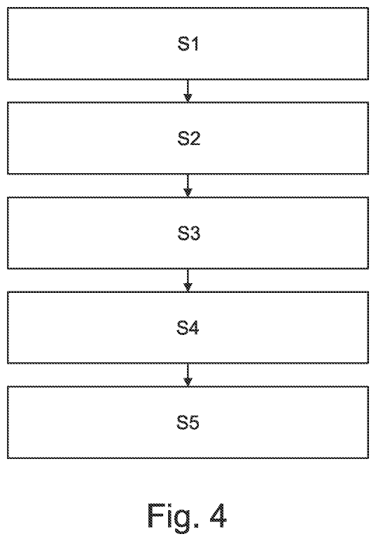

FIG. 1b a schematic perspective view of an embodiment of an additively manufactured component according to the invention, which has been manufactured by the method according to FIG. 4;

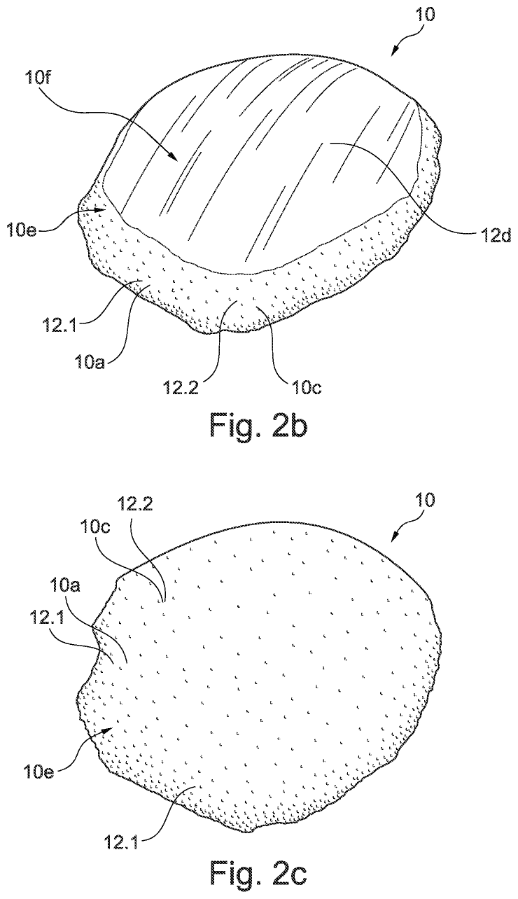

FIG. 2a is a schematic perspective view of an example embodiment of an additively manufactured component;

FIG. 2b a schematic perspective view of an embodiment of an additively manufactured component according to the invention, which has been manufactured by the method according to FIG. 4;

FIG. 2c a schematic perspective view of an embodiment of an additively manufactured component according to the invention, which has been manufactured by the method according to FIG. 4;

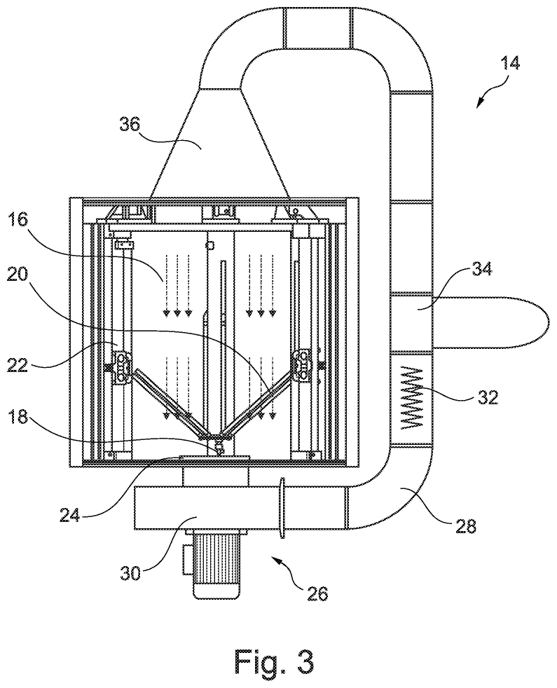

FIG. 3 a schematic front view of an example embodiment of an additive manufacturing device according to the invention; and

FIG. 4 a schematic representation of an example embodiment of a sequence of an additive manufacturing process according to the invention.

FIG. 1a shows a schematic perspective view of an example embodiment of a prior art additively manufactured component 10.

The material layer 12 is formed by one or more so-called infill material strands 12a, which fill the material layer 12 according to predetermined geometric conditions by a filling pattern.

Infill material strands 12a are characterised in that they are dispensed by extrusion of a nozzle head or an extrusion head of an additive manufacturing device (not shown in FIG. 1a) according to the geometric specifications specifically in each individual material layer together with the associated plane.

According to FIG. 1a, the infill material strands 12a for forming the material layer 12 were applied in the uppermost plane within a defined bounding surface (here a square hollow cross-section with rounded corners), so that these infill material strands 12a replicate or fill the defined bounding surface.

The material layer 12 can in principle be formed by a single or multiple infill material strands 12a.

A single infill material strand 12a can be formed such that the entire material layer 12 can be formed without interrupting the extrusion head by this one infill material strand 12a.

Alternatively or additionally, the material layer 12 can be formed by several infill material strands 12a, whereby at each edge point of the defined limiting surface the extrusion head interrupts the extrusion and moves to a further edge point and there starts the extrusion anew and thus gradually builds up the material layer.

The outer and inner circumferential surfaces 10a, 10b serve to illustrate in principle the construction of a single material layer 12 by the infill material strands 12a, whereby, depending on the geometry of the component, only one circumferential surface 10a may be provided (in the case of a solid body) or two, three or even more circumferential surfaces are conceivable (e.g. in the case of complex bionic structures).

Referring to FIG. 1a, there is provided a continuous infill material strand 12a having many infill material strand sections 12b formed straight and parallel to each other and extending to their reversal points 12c within the outer and inner peripheral surfaces 10a, 10b to form the material layer 12.

Accordingly, the material layer 12 is built up infill material strand section 12b by infill material strand section 12b in the striped pattern shown in FIG. 1 until the last infill material strand section 12b contacts and is joined to the first infill material strand section 12b at the last or first reversal point 12c.

The shape of the outer and inner peripheral surfaces 10a, 10b results for each individual material layer essentially from a defined projection plane or the resulting projection geometry of the component, which is assigned to the respective material layer 12.

In this way, the component can be built up layer by layer by means of several material layers 12, whereby the number of material layers can be two-digit, three-digit, four-digit, five-digit, six-digit and so on.

Once a material layer 12 is formed within the defined bounding surfaces (defined according to FIG. 1a by the outer and inner peripheral surfaces 10a, 10b) as described above, the extrusion head adds at least one so-called perimeter material strand 12d to the material layer 12 along the outer and inner peripheral surfaces 10a, 10b.

In this way, the lateral edge roughness of each material layer 12, which is created by the reversal points 12c, is smoothed and thus adapted as precisely as possible to the required geometric projection shape of the material layer 12.

This is precisely where the solution according to the invention comes in, which is described below with reference to FIG. 1b.

Accordingly, FIG. 1b shows a schematic perspective view of an example embodiment of an additively manufactured component 10 according to the invention, which has been manufactured or obtained, for example, by the method according to FIG. 4.

The component 10 is designed as a medical device 10 and in particular as a medical implant, whereby the representation in FIG. 1b is only schematic and does not show any reference to an actual implant.

The medical device 10 has at least a first material layer 12.1.

This first material layer 12.1 is formed by one or more infill material strands 12a similar to FIG. 1a within a first two-dimensional plane.

The medical device 10 further comprises at least one second material layer 12.2, which is also formed by one or more infill material strands 12a, building on the first material layer within a second two-dimensional plane parallel to the first two-dimensional plane.

The one or more infill material strands 12a of the first material layer 12.1 and the second material layer 12.2 are each straight.

Each infill material strand 12a has a plurality of infill material strand sections 12b formed straight and parallel to each other and extending to their reversal points 12c within the outer and inner peripheral surfaces 10a, 10b to form the contour material layer 12.

Additionally or alternatively, the one or more infill material strands 12a of the first material layer 12.1 and the second material layer 12.2 may each be curved.

In contrast to FIG. 1a (according to the prior art), it is provided according to the invention that the first and second material layers 12.1, 12.2 are each formed exclusively by the one or more infill material strands 12a.

Accordingly, the first and second material layers 12.1, 12.2 do not comprise a perimeter material strand 12d as in the prior art.

Alternatively, it is also conceivable that the first or second material layer 12.1, 12.2 are formed exclusively by the one or more infill material strands 12a.

In this case, one of the first or second material layers 12.1, 12.2 not formed exclusively by the one or more infill material strands 12a comprises one or more perimeter material strands 12d (not shown in FIG. 1b).

The background to this structure is that the resulting medical device 10 or implant has surface areas that deliberately form a roughened structure (by omitting perimeter material strands), whereas other surface areas have an essentially smooth structure (by forming at least one perimeter material strand).

The first and second material layers 12.1, 12.2 form the smallest structural unit of the layered medical device 10, wherein it should be noted that the medical device is constructed from a plurality of these smallest structural units (e.g., a two-digit, three-digit, four-digit, five-digit, six-digit, seven-digit or eight-digit number, etc.).

The first material layer 12.1 and the second material layer 12.2 each have a layer thickness in a range of about 0.05 mm to about 0.5 mm.

The one or more infill material strands 12a of the first material layer 12.1 and the second material layer 12.2 also each have a strand thickness in a range of about 0.1 mm to about 1 mm.

When formed, the first material layer 12.1 further comprises a first outer and inner peripheral surface 10a, 10b which externally and internally delimits the first material layer 12.1.

Accordingly, the second material layer 12.2 in the formed state also has a second outer and inner peripheral surface 10c, 10d. which externally and internally delimits the second material layer 12.2.

Depending on the geometric structure of the first and second material layers 12.1, 12.2, these may have only one circumferential surface (in the case of a solid body) or more than two circumferential surfaces (in the case of complex geometric structures).

The first and second outer peripheral surfaces 10a, 10c are further surface treated.

Additionally or alternatively, the first and second inner peripheral surfaces 10b, 10d may also be surface treated.

The surface treatment can be etching or coating.

The coating may contain anti-microbial chemical compounds or anti-inflammatory compounds so that the tendency of the medical device to cause inflammation can be reduced in accordance with its use as an implant.

The first material layer 12.1 and the second material layer 12.2 are each formed from a medically compatible plastic.

Examples of the medically compatible plastic can be PEEK, PEKK, PEI or PPSU.

Additionally or alternatively, the first material layer 12.1 and the second material layer 12.2 can also be formed from a plastic that is absorbable by the human or animal body.

Examples of the plastic that can be absorbed by the human or animal body may include PCL, PDO, PLLA, PDLA, PGA or PGLA.

FIG. 2a shows a schematic perspective view of an example embodiment of an additively manufactured medical component produced by an additive manufacturing process known from the prior art.

As can be seen in FIG. 2a, the medical component 10 has a substantially smooth surface texture, indicating that the respective outer perimeter material strands 12d have been applied accordingly (cf. FIG. 1a).

In its concrete embodiment as a cranial implant, the medical component 10 is comparable to the very abstractly depicted component 10 from the prior art according to FIG. 1a.

The medical component 10 is formed from the biocompatible plastic PPSU.

Other biologically or medically compatible plastics such as PEEK, PEKK or PEI can also be used. The white rectangle on the surface should not be understood as a recess, but as a cover for a lettering, whereby the surface has the same design along its entire extension.

FIG. 2b shows a schematic perspective view of an example embodiment of an additively manufactured medical component 10 according to the invention, which has been manufactured by the method according to FIG. 4. The medical component 10 is designed as a cranial implant which can, for example, replace or support regions of the cranial bone.

The medical component 10 is formed from the biocompatible plastic PPSU.

Other biologically or medically compatible plastics such as PEEK, PEKK or PEI can also be used.

With reference to FIG. 2b, the specific roughened surface areas 10e of the implant can be seen, which are formed by several material layers 12.1, 12.2 that do not have perimeter material strands (see explanations in this regard according to FIGS. 1a, 1b).

However, FIG. 2b also shows a substantially smooth surface area 10f of the implant (central surface area 10f of the implant enclosed by an outer roughened surface area 10).

Accordingly, this surface area 10f is formed by several material layers comprising one or more perimeter material strands 12d (see explanations in this regard according to FIGS. 1a, 1b).

However, the component 10 is not limited to cranial implants, other forms of bone implants such as jaw, neck, shoulder, chest, hip, pelvis, thigh, knee and/or foot implants are also conceivable. Bone or bone marrow screws, nails or plates may also be provided.

The white rectangle at the smooth surface area 10f is not to be understood as a recess, but as a cover for a lettering, whereby the smooth surface area 10f is formed equally along its entire extension.

FIG. 2c shows a further schematic perspective view of an example embodiment of an additively manufactured medical component 10 according to the invention, which has been manufactured by the method according to FIG. 4.

The medical component 10 is also designed as a cranial implant that can, for example, replace or support areas of the cranial bone.

The medical component 10 is formed from the biocompatible plastic PPSU.

Other biologically or medically compatible plastics such as PEEK, PEKK or PEI can also be used.

With reference to FIG. 2c, the entire specifically roughened surface area 10e of the implant can be seen, which is formed by several material layers 12.1, 12.2 that do not have perimeter material strands 12d (see explanations in this regard according to FIGS. 1a, 1b).

However, the component 10 is not limited to cranial implants, other forms of bone implants such as jaw, neck, shoulder, chest, hip, pelvis, thigh, knee and/or foot implants are also conceivable.

Bone or bone marrow screws, nails or plates may also be provided.

The white rectangle on the surface 10e is not to be understood as a recess, but as a cover for a lettering, whereby the surface is formed equally along its entire extension.

FIG. 3 shows a schematic front view of an example embodiment of an additive manufacturing device 14 according to the invention.

The additive manufacturing device 14 for producing a layered component is designed as a 3D printer.

In particular, the 3D printer is designed as an FFF 3D printer.

The additive manufacturing device 14 further comprises a build chamber 16 and an extrusion head 18, which is three-dimensionally movable within the build chamber 16 by means of a corresponding linkage 20 having three arms and three associated linear guides 22.

The additive manufacturing device 14 further comprises a control or regulating device (not shown in FIG. 3) for controlling or regulating the extrusion head 18.

The control or regulating device may alternatively be designed as a control and regulating device for controlling and regulating the extrusion head 18.

A heatable pressure bed 24 is arranged on the bottom side of the construction chamber 16, on which the component or implant to be produced is positioned.

An air supply device 26 is connected to the construction chamber 16, which together with the construction chamber 16 and the corresponding piping forms a closed air circuit 28.

According to FIG. 1, the air circuit 28 has a fan or compressor 30 for extracting and supplying air to the construction chamber 16, as well as a heating device 32, a filter 34 (e.g. a HEPA filter) and a diffuser 36.

The function of the additive manufacturing device 14 can now be described as follows:

The control device is arranged to control the extrusion head 18 in such a way that a first material layer of the implant can be formed by the extrusion head 18.

The first material layer of the component is formed such that one or more infill material strands (see FIG. 1a, 1b and associated description) are built up or formed in a first two-dimensional plane.

Further, the extrusion head forms a second material layer of the component by forming one or more infill material strands, building on the first material layer in a second two-dimensional plane parallel to the first two-dimensional plane.

Furthermore, the control or regulating device is arranged such that the first and second material layers can each be formed by the extrusion head 18 exclusively by the one or more infill material strands.

Alternatively, it is also conceivable that the first or second material layer can be formed exclusively by the one or more infill material strands (see further explanations in FIG. 1b).

FIG. 4 shows a schematic representation of an embodiment of a sequence of an additive manufacturing process according to the invention for manufacturing the medical product according to FIG. 1b and FIG. 2.

The additive manufacturing process in the form of an FFF 3D printing process for a medical device formed of multiple material layers comprises, according to step S1, forming a first material layer of the medical device by forming one or more infill material strands within a first two-dimensional plane.

According to a second step S2, a second material layer of the medical device is accordingly formed by forming one or more infill material strands, building on the first material layer within a second two-dimensional plane parallel to the first two-dimensional plane (cf. also explanations according to FIG. 1b).

However, the first and second steps S1 and S2 are performed such that the first and second material layers are each formed exclusively by the one or more infill material strands (step S3).

Additionally or alternatively, the first or second layer of material may each be formed exclusively by the one or more strands of infill material.

According to a fourth and fifth step S4, S5, a surface treatment can be carried out at least on the first circumferential surface and the second circumferential surface of the first and second material layer respectively (see FIG. 1b and the explanations thereto).

Alternatively, a surface treatment may be performed on the first circumferential surface or the second circumferential surface of the first or second material layer.

Step S4 or S5 of the surface treatment comprises etching or coating.

In principle, it is conceivable here that when coating the outer surface and/or the first material layer and/or the second material layer and/or the coating of the first circumferential surface of the first and/or second material layer respectively has/have a layer thickness in the nano range, in particular in a range up to approx. 250 nm, e.g. up to approx. 150 nm and/or up to approx. 100 nm.

It is also conceivable, for example, that the outer layer is biodegradable and the inner layer has a thickness in the nano range.

With regard to further features of the process according to the invention, which essentially relate to the component or medical device to be manufactured, reference is made to the figure description according to FIG. 1b in order to avoid repetition.

Furthermore, the additive manufacturing device according to the invention described above in accordance with FIG. 3 is set up for carrying out the process according to the invention described above.

### LIST OF REFERENCE SIGNS

10 Component or medical device
10a first outer peripheral surface
10b first inner circumferential surface
10c second outer peripheral surface
10d second inner circumferential surface
10e specific roughened surface areas
10f essentially smooth surface areas
12 Layer of material
12.1 First layer of material
12.2 Second layer of material
12a Infill material strand; Infill material strands
12b Infill material string sections
12c Reversal points
12d Perimeter material strand; perimeter material strands
14 additive manufacturing device; FFF 3D printer
16 Building chamber
18 Extrusion head
20 Linkages
22 Linear guides
24 Printing bed
26 Air supply unit
28 Air circulation
30 Fan
32 Heater
34 Filter
36 Diffuser
S1 first step
S2 second step
S3 third step
S4 fourth step
S5 fifth step

1. Additive manufacturing device, for producing at least one component formed in layers, having at least one building chamber; having at least one extrusion head which can be moved three-dimensionally within the building chamber; and having at least one open-loop and/or closed-loop control device for open-loop and/or closed-loop control of the extrusion head, the open-loop and/or closed-loop control device being set up to open-loop and/or closed-loop control the extrusion head in such a way that at least one first material layer of the component can be formed by the extrusion head by forming one or more infill material strands, in that at least one second material layer of the component can be formed by the extrusion head by forming one or more infill material strands building on the first material layer; and in that the extrusion head forms the first and/or the second material layer exclusively by means of the one or more infill material strands.

2. Additive manufacturing method, for a component formed from a plurality of material layers, comprising the following steps:
forming at least a first material layer of the component by forming one or more infill material strands, and
Forming at least one second material layer of the component by forming one or more infill material strands building on the first material layer,
wherein the first and/or second material layer is or are each formed exclusively by the one or more infill material strands.

3. The manufacturing method according to claim 2, wherein the first material layer in the formed state has at least one first outer circumferential surface which externally delimits the first material layer, wherein at least one surface treatment is carried out at least on the first outer circumferential surface in a further step.

4. A manufacturing method according to claim 3, wherein the second material layer in the formed state has at least one second outer circumferential surface which externally bounds the second material layer, wherein at least one surface treatment is carried out at least on the second outer circumferential surface in a further step.

5. A manufacturing process according to claim 3, wherein the surface treatment comprises at least etching.

6. A manufacturing process according to claim 3, wherein the surface treatment comprises at least coating.

7. A manufacturing method according to claim 2, wherein the first material layer and/or the second material layer each has a layer thickness in a range from about 0.05 mm to about 0.5 mm.

8. A manufacturing method according to claim 2, wherein the one or more infill material strands of the first material layer and/or the second material layer each has or have a strand thickness in a range from about 0.1 mm to about 1 mm.

9. A manufacturing method according to claim 2, wherein the one or more infill material strands of the first material layer and the second material layer are each straight and/or curved.

10. A manufacturing method according to claim 3, wherein the first material layer and the second material layer each comprise at least one medically compatible plastic and/or at least one plastic that is absorbable by the human or animal body.

11. The manufacturing method of claim 2, wherein the first material layer is formed exclusively by the one or more infill material strands and wherein the second material layer, when formed, has at least one second outer peripheral surface which externally bounds the second material layer, wherein one or more perimeter material strands are formed along the second outer peripheral surface.

12. A manufacturing process according to claim 2, wherein the additive manufacturing process is an FFF 3D printing process.

13. A medical device, wherein the medical device is obtained by an additive manufacturing process, according to claim 10, and wherein the medical device comprises at least a first material layer formed by one or more infill material strands;
wherein the medical device comprises at least one second material layer formed by one or more infill material strands building on the first material layer; and
wherein the first and/or second material layer is or are each formed exclusively by the one or more infill material strands.

14. A medical device according to claim 13, wherein the first material layer in the formed state has at least one first outer circumferential surface which externally delimits the first material layer, wherein at least the first outer circumferential surface is surface-treated.

15. A medical device according to claim 13, wherein the second material layer in the formed state has at least one second outer circumferential surface which externally bounds the second material layer, wherein at least the second outer circumferential surface is surface-treated.

16. A medical device according to claim 14, wherein the first and/or second outer peripheral surface comprises an etch.

17. A medical device according to claim 16, wherein the first and/or second outer peripheral surface has a coating.

18. A medical device according to claim 13, wherein the first material layer and/or the second material layer each has a layer thickness in a range from about 0.05 mm to about 0.5 mm.

19. A medical device of claim 13, wherein the one or more infill material strands of the first material layer and/or the second material layer each has or have a strand thickness in a range of about 0.1 mm to about 1 mm.

20. A medical device according to claim 13, wherein the one or more infill material strands of the first material layer and the second material layer is or are each straight and/or curved.

21. A medical device according to claim 13, wherein the first material layer and the second material layer each comprise at least one medically compatible plastic and/or at least one plastic that is absorbable by the human or animal body.

22. A medical device according to claim 13, wherein the first material layer is formed exclusively by the one or more infill material strands and wherein the second material layer, when formed, has at least one second outer peripheral surface which externally bounds the second material layer, wherein one or more perimeter material strands are formed along the second outer peripheral surface.
